(19) United States
(12) Patent Application Publication
(10) Pub. No.: US 2005/0091066 A1
(43) Pub. Date: Apr. 28, 2005

(54) Classification of speech and music using zero crossing

(76) Inventor: Manoj Singhal, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/695,125

(22) Filed: Oct. 28, 2003

(51) Int. Cl. G10L 19/00

(52) U.S. Cl. 704/500

(57) ABSTRACT

Disclosed herein is a method and system for classifying an audio signal. The method may be accomplished by using a low pass filter to prevent transmission of audio components having a frequency greater than a predetermined frequency. The system may also be provided with a device for selecting a further reduced number of audio components for analysis. Analysis of the audio signal may be performed by a zero point counter for counting and recording zero point transitions encountered in analysis of the audio signal. The system may also include a comparator for comparing a result of analysis to a threshold value and classifying the audio signal based upon comparison of the result of analysis and the threshold value.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Human beings, with normal hearing, are often able to distinguish sounds from about 20 Hz, such as the lowest note on a large pipe organ, to 20,000 Hz, such as the high shrill of a dog whistle. Human speech, on the other hand, ranges from 300 Hz to 4,000 Hz.

Music may be produced by playing musical instruments. Musical instruments often produce sounds that lie outside the range of human speech, and in many instances, produce sounds (overtones, etc.) which lie outside the range of human hearing.

An audio communication can comprise either music, speech or both. However, conventional equipment processes audio communication signals comprising only speech in a similar manner as communication signals comprising music.

Further limitations and disadvantages of conventional and traditional approaches will become apparent to one of skill in the art, through comparison of such systems with embodiments presented in the remainder of the present application with references to the drawings.

### SUMMARY OF THE INVENTION

Aspects of the present invention may be found in a method for classifying an audio signal. The method may comprise receiving an audio signal to be classified, analyzing selected audio signal components, recording a result of analysis of the selected audio signal components, comparing the recorded result of analysis to a threshold value, and classifying the audio signal based upon comparison of the recorded result of analysis and the threshold value.

In another embodiment of the present invention, classifying the audio signal based upon comparison of the recorded result of analysis and the threshold value may further comprise: if the recorded result of analysis is greater than the threshold value, then the audio signal is determined to be music; and if the recorded result of analysis is less than the threshold value, then the audio signal is determined to be speech.

In another embodiment of the present invention, analyzing the selected audio signal components may comprise counting zero point transitions of the selected audio signal components.

In another embodiment of the present invention, recording a result of analysis of the selected audio signal components may comprise recording a count value of a number of zero point transitions of the selected audio signal components.

In another embodiment of the present invention, transmitting components of the audio signal having a frequency less than a predetermined frequency may comprise passing the audio signal through a low pass filter. The low pass filter may be adapted to permit transmission of frequencies below the predetermined frequency.

In another embodiment of the present invention, selecting a number of transmitted audio signal components for analysis comprises passing transmitting digital audio components through a decimator. Every 1 in N audio signal components may be transmitted and audio signal components between 1 and N may be discarded.

In another embodiment of the present invention, classifying the audio signal may further comprise turning on a flag in a header of a packet of digital audio information. The flag provides an indication of classification of the audio signal based upon comparison of the recorded result of analysis and the threshold value.

In another embodiment of the present invention, the method may further comprise transmitting components of the audio signal having a frequency less than a predetermined frequency and selecting a number of transmitted audio signal components for analysis.

In another embodiment of the present invention, classifying the audio signal may occur at a transmitting end of an audio transmission system.

In another embodiment of the present invention, classifying the audio signal may occur at a receiving end of an audio transmission system.

In another embodiment of the present invention, the audio signal is one of an analog signal and a digital signal.

In another embodiment of the present invention, the threshold value used in the comparison is pre-determined and pre-set by a user.

In another embodiment of the present invention, the threshold value used in the comparison determined through trial and error of a plurality of iterations in a comparing device.

In another embodiment of the present invention, analyzing selected audio signal components may comprise counting zero point transitions of the audio signal for a predetermined period of time.

In another embodiment of the present invention, the method may further comprise converting the audio signal from an analog signal to a digital signal, encoding the audio signal, packetizing the audio signal, transmitting the audio signal, decoding the audio signal, and processing the audio signal. Processing may at least comprise one of storing the audio signal and playing the audio signal.

Aspects of the present invention may also be found in an apparatus for classifying an audio signal. The apparatus may comprise a zero point counter for counting and recording zero point transitions encountered in analysis of the selected audio signal components and a comparator for comparing a recorded result of analysis to a threshold value and classifying the audio signal based upon comparison of the recorded result of analysis and the threshold value.

In another embodiment of the present invention, classifying the audio signal based upon comparison of the recorded result of analysis and the threshold value in the comparator may further comprise: if the recorded result of analysis is greater than the threshold value, then the audio signal is determined to be music; and if the recorded result of analysis is less than the threshold value, then the audio signal is determined to be speech.

In another embodiment of the present invention, the apparatus may further comprise a low pass filter for preventing transmission of components of the audio signal having a frequency greater than a predetermined frequency and a decimator for selecting a reduced number of audio components for analysis.

In another embodiment of the present invention, the decimator selecting a reduced number of audio components for analysis may further comprise the decimator selecting every 1 in N audio signal components to be transmitted and selecting the audio signal components between 1 and N to be discarded.

In another embodiment of the present invention, the apparatus may further comprise at least one of an audio signal encoder and an audio signal decoder.

In another embodiment of the present invention, the apparatus may further comprise a speech/music classifying device being associated with the audio signal encoder.

In another embodiment of the present invention, the apparatus may further comprise a speech/music classifying device associated with the audio signal decoder.

In another embodiment of the present invention, the apparatus may further comprise a signal processor and an audio processing unit associated with the audio signal decoder.

In another embodiment of the present invention, the apparatus may further comprise a bitstream multiplexer associated with the audio signal decoder.

These and other advantages and novel features of the present invention, as well as details of an illustrated embodiment thereof, will be more fully understood from the following description and drawings.

### BRIEF DESCRIPTION OF THE DRAWINGS

FIG. 1 illustrates a portion of an audio communication received by an electronic device according to an embodiment of the present invention;

FIG. 2 illustrates a portion of an analog audio signal according to an embodiment of the present invention;

FIG. 3 illustrates a portion of an analog audio signal being sampled for conversion to a digital signal according to an embodiment of the present invention;

FIG. 4 illustrates a portion of a digital audio signal according to an embodiment of the present invention;

FIG. 4A is a flowchart illustrating a method of classifying whether an audio communication is speech or music according to an embodiment of the present invention;

FIG. 5 illustrates an apparatus for classifying an audio signal as either speech or music using zero crossing analysis according to an embodiment of the invention;

FIG. 6 is a flow chart illustrating an exemplary processing method performed by the apparatus of FIG. 5 for classifying an audio signal as speech or music using a zero crossing counting method according to an embodiment of the present invention;

FIG. 7 is a block diagram illustrating a system for converting, classifying, encoding, and packetizing an audio communication according to an embodiment of the present invention;

FIG. 8 is a block diagram illustrating encoding of an exemplary audio signal A(t) according to an embodiment of the present invention; and

FIG. 9 is a block diagram illustrating an exemplary audio decoder according to an embodiment of the present invention.

### DETAILED DESCRIPTION OF THE INVENTION

Modern electronic devices are adapted to transmitting and receiving both music and speech. In audio communication, any interruption of music transmission, such by speech transmission, may be interpreted as a commercial or an advertisement, or vice versa.

An aspect of the present invention may be found in a method and system for classifying whether a communication received is speech or music by applying a zero crossing analysis method to the communication.

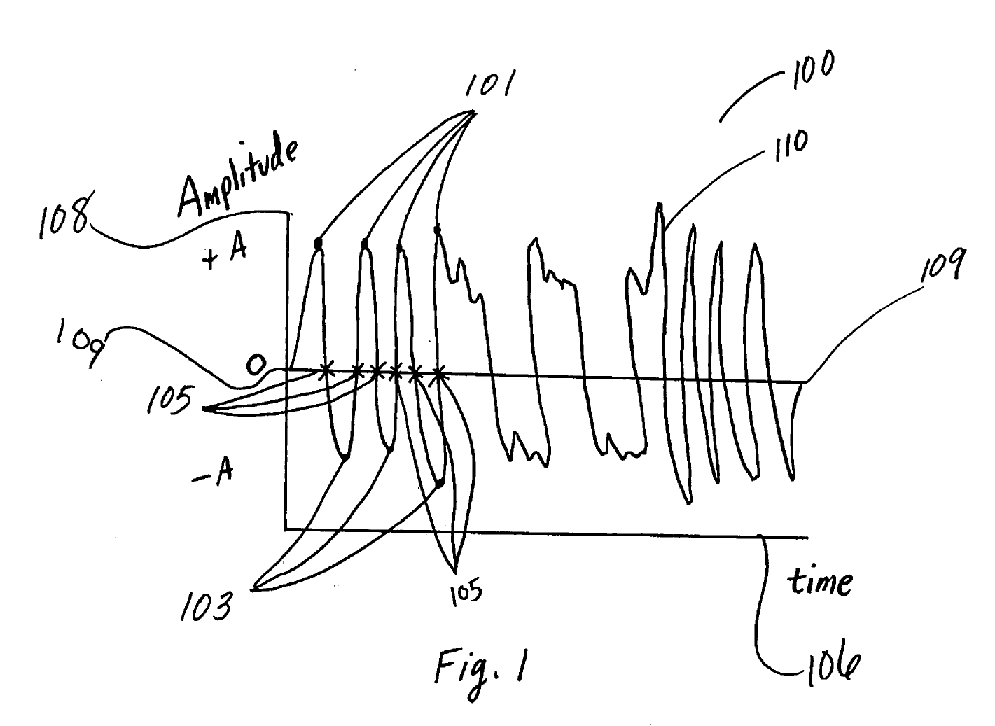

FIG. 1 illustrates a portion 100 of an audio communication 110 received by an electronic device according to an embodiment of the present invention. The audio communication 110 comprises an analog or digital audio signal having a bandwidth or spectrum. The audio communication 110 oscillates between positive amplitude maxima 101 and negative amplitude maxima 103, crossing a zero point 109 (zero point crossings 105 marked by X's) as each oscillation transitions from positive to negative values. The audio communication 110 is illustrated in terms of the amplitude 108 (Y-Axis) with respect to time 106 (X-axis).

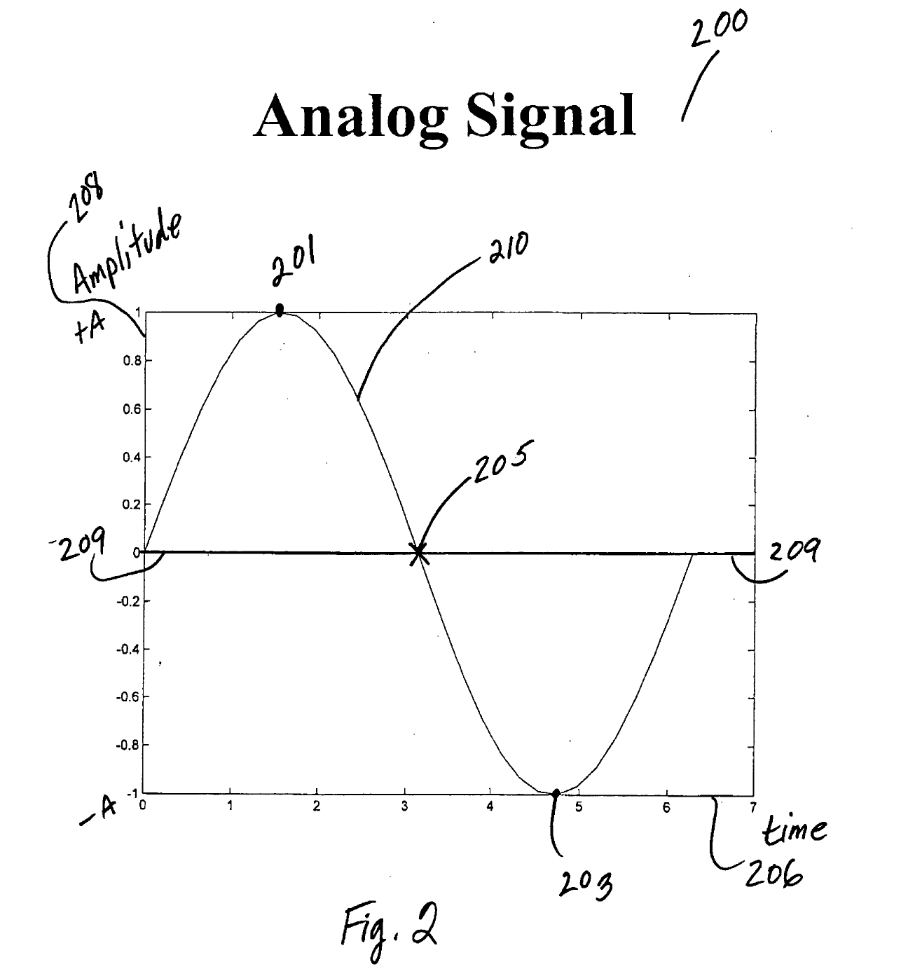

FIG. 2 illustrates a portion 200 of an analog audio signal 210. The analog audio signal 210 comprises a bandwidth or spectrum. The analog audio signal 210 oscillates between a positive amplitude 201 and a negative amplitude 203, crossing a zero point 209 (the zero point crossing 205 marked by an X) as each oscillation transitions from positive to negative values. The analog audio signal 210 is illustrated in terms of the amplitude 208 (Y-Axis) with respect to time 206 (X-axis).

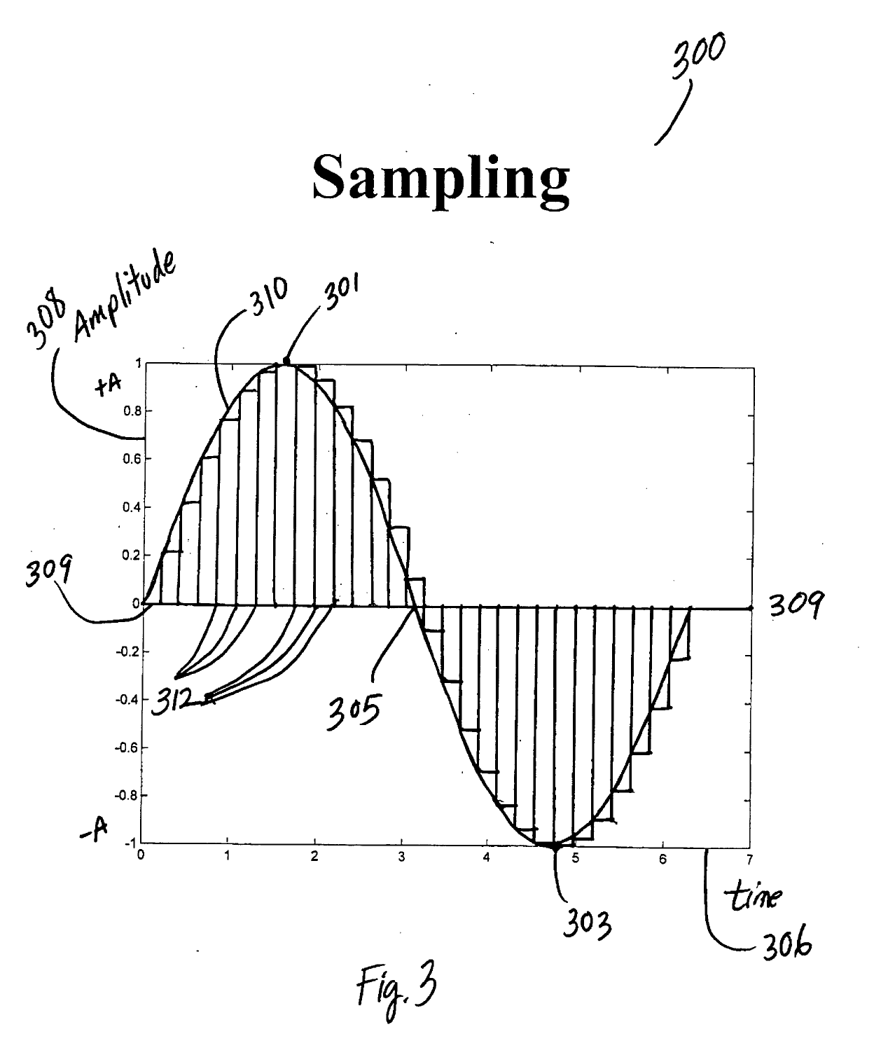

FIG. 3 illustrates a portion 300 of an analog audio signal 310 being sampled for conversion to a digital signal according to an embodiment of the present invention. The audio signal 310 comprises a bandwidth or spectrum and has been divided into a plurality of discrete samples 312. The samples 312 approximate the analog audio signal 310. The analog audio signal 310 oscillates between a positive amplitude 301 and a negative amplitude 303, crossing a zero point 309 (the zero point crossing 305 marked by an X) as each oscillation transitions from positive to negative values. The sampled audio signal 310 is illustrated in terms of the amplitude 308 (Y-Axis) with respect to time 306 (X-axis).

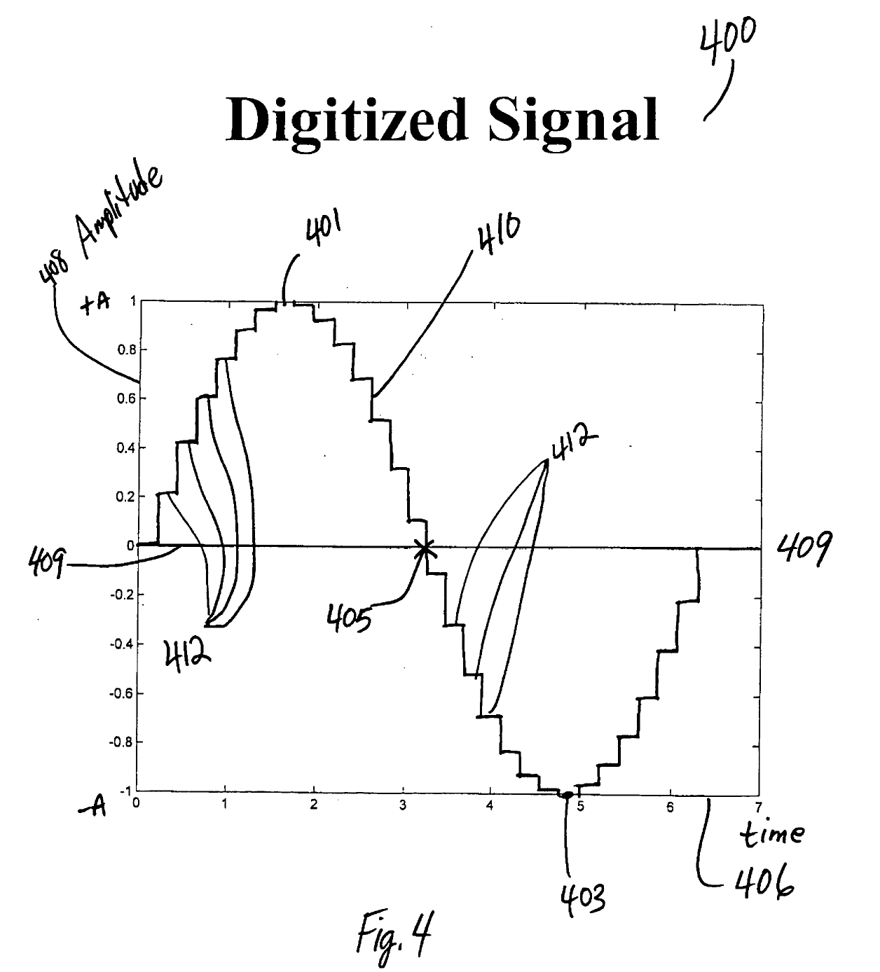

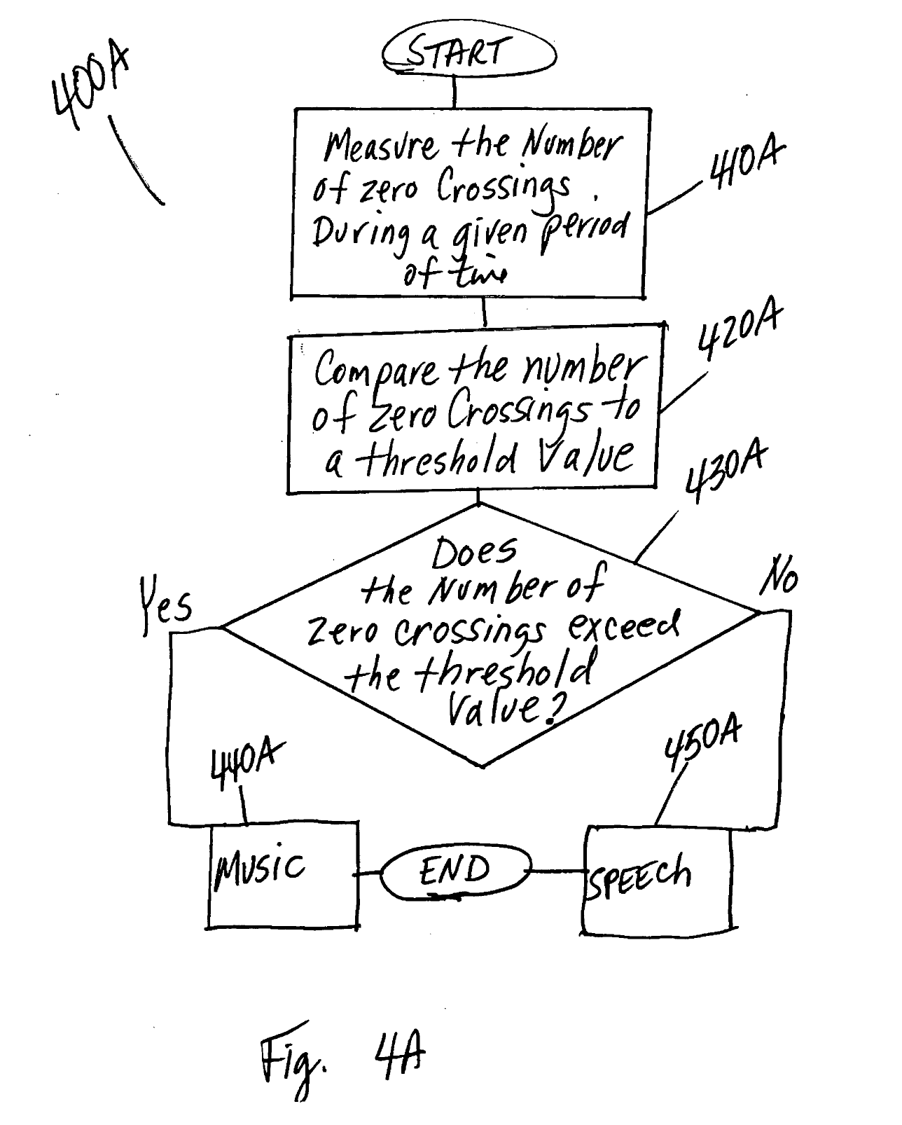

FIG. 4 illustrates a portion 400 of a digital audio signal 410 according to an embodiment of the present invention. The digital audio signal 410 comprises a bandwidth or spectrum and is shown approximating the analog signal 210 through a plurality of quantized discrete samples 412. The digital audio signal 410 transitions through a positive amplitude 401 and a negative amplitude 403 over time, crossing a zero point 409 (the zero point crossing 405 marked by an X). The digital audio signal 410 is illustrated in terms of the quantized amplitude 408 (Y-Axis) with respect quantized time 406 (X-axis).

A digital audio signal is an audio signal using binary code to represent audio information. The signals are modeled so that the information being transmitted is translated into a series of zeros and ones, i.e., a range of analog values are associated with a logical value. Digital systems process time varying signals that can take on any value quantized from a continuous range of electrical values. The digital audio transmission system takes the audio information and represents it as a series of bits represented in code by zeros and ones.

On the other hand, an analog audio communication is a way of sending signals in which the communicated audio signal is a wave reflecting the original signal. An analog audio communication system attempts to recreate the audio information as it actually happens. Analog systems process time varying signals that can take any value across a continuous electrical values.

Human beings with normal hearing can detect sounds from about 20 Hz to about 20,000 Hz. Human speech, on the other hand, ordinarily ranges from about 300 Hz to about 4,000 Hz. Music produces audible sounds that lie outside the range of human speech (20 to 20,000 Hz) but within the range of human speech (300 to 4,000 Hz).

There are various reasons for determining whether the audio communication is associated with speech or music. For example, it may be advantageous to process audio communications associated with speech in one manner and audio communications associated with music in another manner.

Whether the audio communication is associated with speech or music can be determined by measuring the number of times the audio signal crosses the zero point (zero point crossing) during a given period of time. The higher the number of zero point crossings 105, the greater the likelihood that the audio communication is associated with music, while the lower the number of zero point crossings 105, the greater the likelihood that the audio communication is associated with speech.

Accordingly, the number of zero point crossings can be compared to a threshold. If the number of zero point crossings exceeds a predetermined threshold value which can be computed offline by analyzing the given audio signal, a determination can be made that the audio communication is associated with music. If the threshold value exceeds the number of zero point crossings, a determination is made tat the audio communication is associated with speech.

FIG. 4A is a flowchart 400A illustrating a method of classifying whether an audio communication is speech or music according to an embodiment of the present invention. At block 410A, the flowchart illustrates measuring the number of zero crossings during a given period of time. At block 420A, the flowchart illustrates comparing the number of zero crossings to a threshold value. At decision block 430A, the result of the comparison is determined and the question of whether the number of zero crossings exceeds the threshold value is answered. If the number of zero crossings is greater than the threshold value (Yes), then the audio signal is determined to be music 440A. However, if the number of zero crossings is less than the threshold value (No), then the audio signal is determined to be speech 450A.

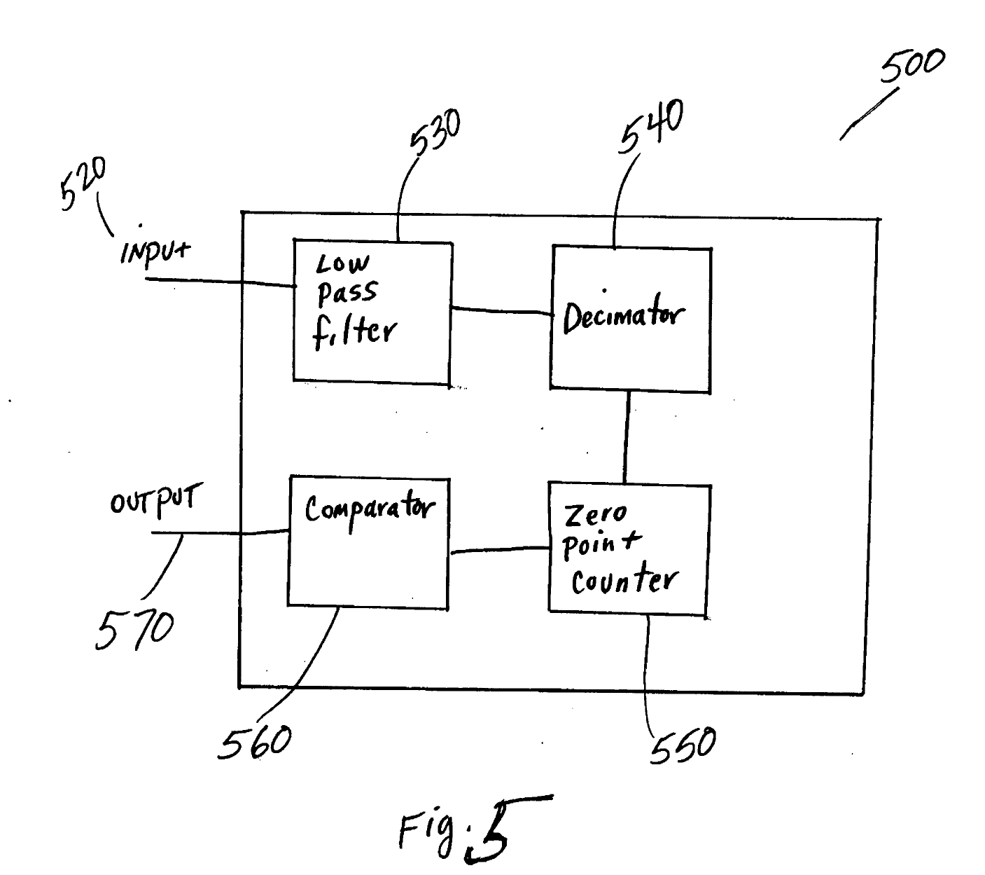

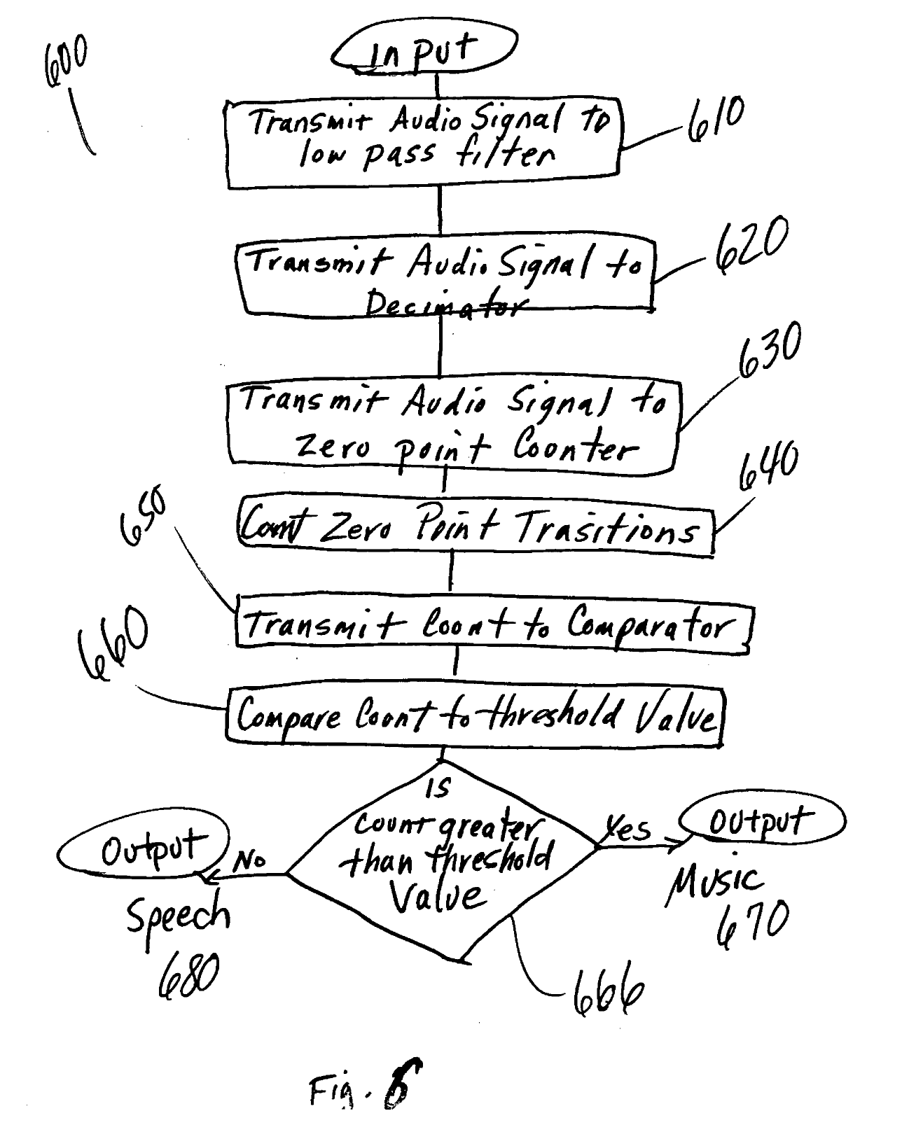

FIG. 5 illustrates an apparatus 500 for classifying an audio signal as either speech or music using zero crossing analysis according to an embodiment of the invention. The apparatus 500 comprises an input 520, a low pass filter 530, a decimator 540, a zero point counter 550, a comparator 560, and an output 570. An exemplary signal processing method performed by the apparatus will be described in detail in FIG. 6.

FIG. 6 is a flow chart 600 illustrating an exemplary processing method performed by the apparatus of FIG. 5 for classifying an audio signal as speech or music using a zero crossing counting method according to an embodiment of the present invention. In order to classify the audio signal illustrated in FIG. 1 as speech or music, the audio signal may be passed through a low pass filter 610. The low pass filter may be a filter, which permits transmission of audio signals having a frequency between 0 and 4,000 Hz, while blocking or preventing those audio signals having a frequency greater than 4,000 Hz from being transmitted.

The low pass filter 530 permits analysis of audio that may be characteristic of human speech because that portion of the audio signal spectrum outside the range of human speech has been filtered from further transmission by the low pass filter 530. Thus, the low pass filter 530 also reduces the amount of audio information to be analyzed by limiting the information to that which may at least comprise human speech.

The filtered signal, if digital, may also be passed (620) through a decimator 540. The decimator 540 further limits the amount of audio information to be analyzed by reducing the resolution of the digital audio signal. The decimator may be adapted to permit transmission of one audio signal transition (i.e., sample) in N, where N may be an integer selected to provide a particular level of discrimination.

The portions of the audio signal not selected for further analysis, i.e., those audio signal transitions between 1 and N, may be discarded. After passing the signal through the decimator 540, the amount of audio signal information to be analyzed has been further reduced.

The audio signal information may be passed (630) through a zero point counter 550. In the zero point counter 550, every time the audio signal transitions from positive to negative value or from negative to positive value, the audio signal crosses the zero point boundary, a count is advanced (640) one integer count. When an audio signal over a predetermined time interval has been zero point counted, or when the counting has taken place for a predetermined amount of time, the recorded count value is transmitted (650) to a comparator 560.

In the comparator 560, the recorded count value is compared (660) to a threshold count value 660. The comparator determines if the recorded count is greater than the threshold value 666. If the recorded count value is greater than the threshold count value (Yes), then the audio signal is determined to be music 670, however, if the recorded count value is less than the threshold count value then (No), the audio signal is determined to be speech 680.

The comparator 560 may comprise at least one buffer for storing audio signal information during comparison. The comparator 560 may be adapted to process the signal with even finer discrimination, i.e., determine more about the signal than just whether the signal is music or speech. For example, if the signal is determined to be speech, the frequency range compatible with human speech may be further compared to a sub-threshold value to determine if the speech is male speech, female speech, adult speech, or child speech based upon the number of zero crossings the signal comprises in a particular corresponding frequency range.

Additionally, if the signal is determined to be music, a different sub-threshold value may be used to determine what characteristic instrument(s) are making the music based upon the zero crossings the signal comprises in a particular corresponding frequency range.

In general, the dominant classifying sub-band, as determined from the comparison of the number of zero crossings to the threshold value, may be further divided and mathematically analyzed to glean additional information about the identity of the producer of the sound represented by the audio signal.

The threshold value may be predetermined and provided by a user, or alternatively may be learned through a training process in the comparator, wherein the comparator, through trial and error, determines the threshold value. The comparator may compare the zero crossing count to the threshold value and output a classification of the audio signal as being one of music or speech.

An audio signal comprising human speech has fewer zero point crossings than one comprising music, and thus a lower recorded count value. The reason the reason the audio signal comprising human speech has fewer zeros crossings is a result of the physical size of the human vocal tract, which is unable to oscillate beyond a certain frequency. The human vocal tract produces sound having a limited fundamental frequency (i.e., pitch). Speech harmonics are mostly restricted to below 4 KHz, i.e., most of the speech audio signal energy lies within a 0 to 4 KHz spectrum.

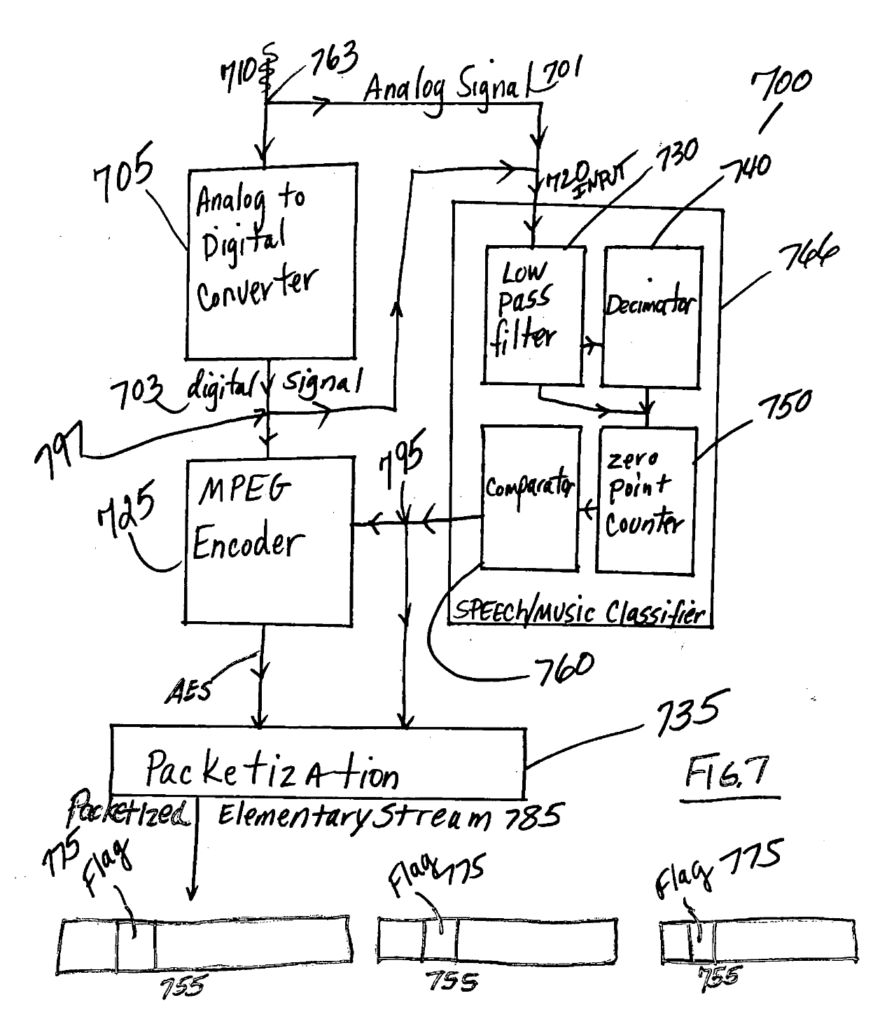

FIG. 7 is a block diagram illustrating a system 700 for converting, classifying, encoding, and packetizing an audio communication according to an embodiment of the present invention. In FIG. 7, the system 700 receives an audio communication 710, wherein the audio communication may be either an analog signal 701 or a digital signal 703. The audio signal 710 may proceed directly to speech/music classification apparatus 766 as an analog signal 701 at junction 763. Alternatively, the audio signal 710 may be passed through analog to digital converter 705 for conversion to a digital signal 703 that is provided via junction 797 to the speech/music classification apparatus 766. After conversion from analog to digital, the digital signal 703 may be passed to MPEG encoder 725. The circumstances of the audio signal processing at the MPEG encoder will be described below.

The audio signal may arrive at the speech/music classifying apparatus 766 at input 720. The signal is then passed through low pass filter 730 where those frequencies above 4,000 KHz (i.e., those frequencies outside the range of human speech) are discarded. If the signal is an analog signal 701, decimator 740 is by-passed and the signal is passed directly from the low pass filter 730 to the zero point counter 750. However, if the signal is a digital signal 703, the signal is passed to the decimator 740 and the amount of data is further reduced. Only a digital signal, may be processed by decimator 740. At the decimator 740, 1 in N samples are retained, while all the intervening samples are discarded. N may be chosen to be any desired integer and may be determined in advance by a user.

When the signal arrives at the zero point counter 750, the zero point transitions (each time the signal crosses the zero point) are counted. The zero point counter 750 continues to count zero crossings for a predetermined period of time. After the predetermined period of time has expired, a zero crossing count value is passed to comparator 760. Comparator 760 is adapted to compare the zero crossing count value to a threshold value. The threshold value may be pre-set by a user, or the comparator may determine (learn) the threshold value through trial and error. If the zero crossing count value is greater than the threshold value, then the output from the speech/music classifying apparatus 766 is that the audio signal is determined to be music. However, if the zero crossing count value is less than the threshold value, then the output from the classifying apparatus 766 is that the audio signal is speech.

The signal may then be passed to either MPEG encoder 725 or alternatively to packetization engine 735 via junction 795. The MPEG encoder 725 converts the digital signal 703 to an audio elementary stream (AES) encoding the digital signal in accordance with the MPEG standard. When the AES is directed to the packetization engine 735, the AES is packetized into a packetized audio elementary stream comprising packets 755. Each packet comprises a portion of the AES and may also comprise a flag 775. The flag 775 may indicate that the portion of the AES in the packet is speech or music depending upon the state of the flag, i.e., whether the flag is turned on or off.

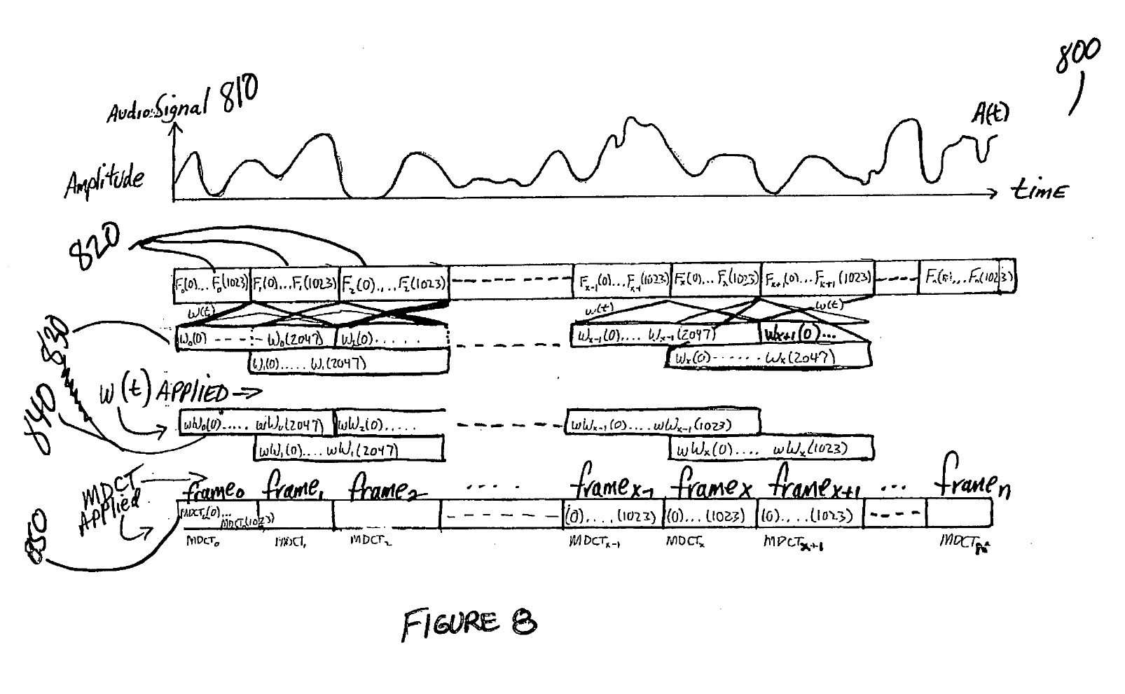

FIG. 8 is a block diagram 800 illustrating encoding of an exemplary audio signal A(t) 810 by the MPEG encoder 725 according to an embodiment of the present invention. The audio signal 810 is sampled and the samples are grouped into frames 820 (F₀ . . . . Fₙ) of 1024 samples, e.g., (Fₓ(0) . . . Fₓ(1023)). The frames 820 (F₀ . . . . Fₙ) are grouped into windows 830 (W₀ . . . Wₙ) that comprise 2048 samples or two frames, e.g., (Wₓ(0) . . . . Wₓ(2047)). However, each window 830 Wₓ has a 50% overlap with the previous window 830 Wₓ₋₁.

Accordingly, the first 1024 samples of a window 830 Wₓ are the same as the last 1024 samples of the previous window 830 Wₓ₋₁. A window function w(t) is applied to each window 830 (W_{0 . . . W}ₙ), resulting in sets (wW₀ . . . wWₙ) of 2048 windowed samples 840, e.g., (wWₓ(0) . . . wWₓ(2047)). The modified discrete cosine transformation (MDCT) may be applied to each set (wW₀ . . . wWₙ) of windowed samples 840 (wWₓ(0) . . . wWₓ(2047)), resulting sets (MDCT₀ . . . MDCTₙ) of 1024 transformation frequency coefficients 850, e.g., (MDCTₓ(0) . . . MDCTₓ(1023)). Although an MDCT transformation has been described for purposes of example, other mathematical transformations may be used as processing requires. For example, Fast Fourier Transformation (FFT), Wavelet transformation, etc., may be used to compute the frequency components for the audio signal rather than restricting computation to MDCT transform coefficients. Transformation coefficients may be referred to as coefficients T₀ . . . T_{N}.

The MPEG encoder receives the output of the speech/music classification apparatus. Based upon the output of the speech/music classification apparatus, the MPEG encoder 725 can take any number of actions with respect to the transformation coefficients T₀ . . . T_{N}. For example, where the output indicates that the content associated with the audio signal 810 is speech, the MPEG encoder 725 can either discard or quantize with fewer bits the transformation coefficients T₀ . . . T_{N} associated with frequencies outside the range of human speech, i.e., exceeding 4 KHz. Where the output indicates that the content associated with the audio signal 810 is music, the MPEG encoder 775 can quantize the transformation coefficients T₀ . . . T_{N} associated with frequencies outside the range of human speech.

The sets of transformation coefficients T₀ . . . T_{N} may then be quantized and coded for transmission, forming what is known as an audio elementary stream (AES). The AES can be multiplexed with other AESs. The multiplexed signal, known as the Audio Transport Stream (Audio TS) can then be stored and/or transported for playback on a playback device. The playback device can either be local or remotely located.

Where the playback device is remotely located, the multiplexed signal is transported over a communication medium, such as the Internet. During playback, the Audio TS is de-multiplexed, resulting in the constituent AES signals. The constituent AES signals are then decoded, resulting in the audio signal.

Alternatively, the transformation coefficients T₀ . . . T_{N} may be packetized by the packetization engine of FIG. 7. In an audio signal, each frame may comprise transformation coefficients T₀ . . . T_{N}. Sub-frame contents may correspond to a particular range of audio frequencies.

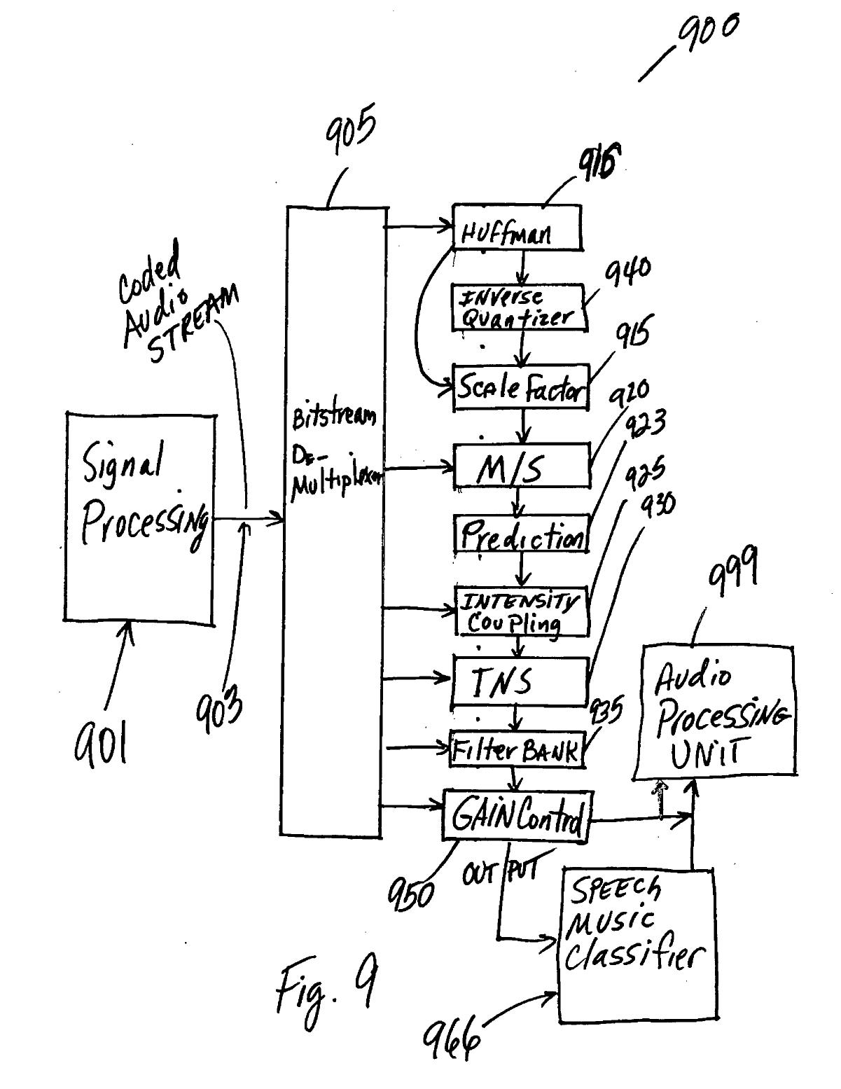

FIG. 9 is a block diagram illustrating an exemplary audio decoder according to an embodiment of the present invention. Referring now to FIG. 9, once the frame synchronization is found and delivered from signal processor 901, the advanced audio coding (AAC) bitstream 903 is de-multiplexed by a bitstream de-multiplexer 905. This includes Huffman decoding 916, scale factor decoding 915, and decoding of side information used in tools such as mono/stereo 920, intensity stereo 925, TNS 930, and the filterbank 935.

The sets of transformation coefficients T₀ . . . T_{N} are decoded and copied to an output buffer in a sample fashion. After Huffman decoding 916, an inverse quantizer 940 inverse quantizes each set of transformation coefficients T₀ . . . T_{N} by a 4/3 power nonlinearity. The scale factors 915 are then used to scale sets of transformation coefficients T₀ . . . T_{N} by the quantizer step size.

Additionally, tools including the mono/stereo 920, prediction 923, intensity stereo coupling 925, TNS 930, and filterbank 935 can apply further functions to the sets of transformation coefficients T₀ . . . T_{N}. The gain control 950 transforms the transformation coefficients T₀ . . . T_{N} into the time domain signal A(t). The gain control 950 may transform the transformation coefficients T₀ . . . T_{N} by application of the Inverse MDCT (IMDCT), inverse window function, window overlap, and window adding, for example, however other mathematical functions may be applied to the transform coefficients T₀ . . . T_{N}. The gain control 950 also looks at the flag 775. The flag 775 is a bit that may be either on or off, i.e., having binary digital value of 1 or zero, respectively. For example, if the bit is on, this indicates that the audio signal is music, and if the bit is off, this indicates that the audio signal is speech, or vice versa.

If the flag 775 indicates that the audio signal is speech the gain control may discard frequency coefficients greater than 4,000 Hz and then perform the decoding by performing the Inverse MDCT function, for example. The gain control 950 may also report results directly to the audio processing unit 999 for additional processing, playback, or storage.

Another music/speech classifier 966, such as the speech/music classifier 500 disclosed in FIG. 5, may be provided at the decoder 900, so that in the circumstance where the signal has been received at the decoder 900 without being classified as one of speech or music, the signal may then be classified. The signal and the speech/music classification apparatus 966 output can be passed to an audio processing unit 999 for processing, playback, or further analysis, as desired.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for classifying an audio signal, the method comprising:
receiving an audio signal to be classified;
analyzing selected audio signal components;
recording a result of analysis of the selected audio signal components;
comparing the recorded result of analysis to a threshold value; and
classifying the audio signal based upon comparison of the recorded result of analysis and the threshold value.

2. The method according to claim 1, wherein classifying the audio signal based upon comparison of the recorded result of analysis and the threshold value further comprises:
if the recorded result of analysis is greater than the threshold value, then the audio signal is determined to be music; and
if the recorded result of analysis is less than the threshold value, then the audio signal is determined to be speech.

3. The method according to claim 1, wherein analyzing the selected audio signal components comprises counting zero point transitions of the selected audio signal components.

4. The method according to claim 1, wherein recording a result of analysis of the selected audio signal components comprises recording a count value of a number of zero point transitions of the selected audio signal components.

5. The method according to claim 1, wherein transmitting components of the audio signal having a frequency less than a predetermined frequency comprises passing the audio signal through a low pass filter, the low pass filter being adapted to permit transmission of frequencies below the predetermined frequency.

6. The method according to claim 1, wherein selecting a number of transmitted audio signal components for analysis comprises passing transmitting digital audio components through a decimator, wherein every 1 in N audio signal components is transmitted and audio signal components between 1 and N are discarded.

7. The method according to claim 1, wherein classifying the audio signal further comprises turning on a flag in a header of a packet of digital audio information, wherein the flag provides an indication of classification of the audio signal based upon comparison of the recorded result of analysis and the threshold value.

8. The method according to claim 1, further comprising:
transmitting components of the audio signal having a frequency less than a predetermined frequency; and
selecting a number of transmitted audio signal components for analysis.

9. The method according to claim 1, wherein classifying the audio signal occurs at a transmitting end of an audio transmission system.

10. The method according to claim 1, wherein classifying the audio signal occurs at a receiving end of an audio transmission system.

11. The method according to claim 1, wherein the audio signal is one of an analog signal and a digital signal.

12. The method according to claim 1, wherein the threshold value used in the comparison is pre-determined and pre-set by a user.

13. The method according to claim 1, wherein the threshold value used in the comparison determined through trial and error of a plurality of iterations in a comparing device.

14. The method according to claim 1, wherein analyzing selected audio signal components comprises counting zero point transitions of the audio signal for a predetermined period of time.

15. The method according to claim 1, further comprising:
converting the audio signal from an analog signal to a digital signal;
encoding the audio signal;
packetizing the audio signal;
transmitting the audio signal;
decoding the audio signal; and
processing the audio signal, wherein processing at least comprises one of storing the audio signal and playing the audio signal.

16. An apparatus for classifying an audio signal, the apparatus comprising:
a zero point counter for counting and recording zero point transitions encountered in analysis of the selected audio signal components; and
a comparator for comparing a recorded result of analysis to a threshold value and classifying the audio signal based upon comparison of the recorded result of analysis and the threshold value.

17. The apparatus according to claim 16, wherein classifying the audio signal based upon comparison of the recorded result of analysis and the threshold value in the comparator further comprises:
if the recorded result of analysis is greater than the threshold value, then the audio signal is determined to be music; and
if the recorded result of analysis is less than the threshold value, then the audio signal is determined to be speech.

18. The apparatus according to claim 16, further comprising:
a low pass filter for preventing transmission of components of the audio signal having a frequency greater than a predetermined frequency; and
a decimator for selecting a reduced number of audio components for analysis.

19. The apparatus according to claim 18, wherein the decimator selecting a reduced number of audio components for analysis comprises the decimator selecting every 1 in N audio signal components to be transmitted and selecting the audio signal components between 1 and N to be discarded.

20. The apparatus according to claim 16, further comprising at least one of an audio signal encoder and an audio signal decoder.

21. The apparatus according to claim 20, further comprising a speech/music classifying device being associated with the audio signal encoder.

22. The apparatus according to claim 20, further comprising a speech/music classifying device being associated with the audio signal decoder.

23. The apparatus according to claim 20, further comprising a signal processor and an audio processing unit associated with the audio signal decoder.

24. The apparatus according to claim 20, further comprising a bitstream multiplexer associated with the audio signal decoder.
